(19) United States
(12) Patent Application Publication
(10) Pub. No.: US 2002/0087664 A1
(43) Pub. Date: Jul. 4, 2002

(54) Medical system architecture with a workstation and a call system

(76) Inventors: Thomas Birkhoelzer, Radolfzell (DE); Karlheinz Dorn, Kalchreuth (DE); Thomas Reichert, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/992,974

(22) Filed: Nov. 19, 2001

(30) Foreign Application Priority Data
Nov. 17, 2000 (DE) 10057024.0
Nov. 9, 2001 (DE) 10154686.6

(51) Int. Cl. G06F 15/16

(52) U.S. Cl. 709/219; 709/206

(57) ABSTRACT

In a medical system architecture with a modality for acquiring examination images, a workstation allocated to the modality for acquiring and/or post-processing data and/or examination images, a device for the transmission of data and of the examination images, a device for storing the data and examination images, and with further workstations for post-processing the data and examination images, a call system for the transmission of messages is allocated to at least one of the workstations.

### BACKGROUND OF THE INVENTION

1. Field of the Invention

The present invention is directed to a medical system architecture of the type having a modality for acquiring examination images, with a workstation allocated to the modality for acquiring and/or post-processing data and/or examination images, a device for the transmission data and of the examination images, a device for storing the data and examination images, and with further workstations for the post-processing of the data and examination images.

2. Description of the Prior Art

System architectures of the above type serve, for example, for generating and processing medical examination images in hospitals in order to prepare diagnoses of patients.

The book “Bildgebende Systeme für die medizinische Diagnostik”, edited by H. Morneburg, 3^{rd} Edition, 1995, pages 684 ff., as well as European Application 0 380 966 disclose medical system architectures, referred to as PACS (Picture Archival and Communication Systems) wherein image viewing and image processing locations, referred to as work stations, are connected to one another via an image communication network for fetching patient data and images generated by modalities. The transmission of the image data ensues according to a standard for radiological information systems, for example DICOM. In contrast to normal PCs, such medical workstations, specifically the modalities, are viewed as closed systems, i.e., medical devices wherein additional software cannot simply be installed. The governing regulating authorities also do not allow this.

In many instances, an operator, an MTRA, independently carries out an examination at a modality, or conducts post-processing at the workstation without a physician, an expert, being present. If deviations from the normal workflow occur in these tasks, for example because of special circumstances or results, a consultation with or, respectively, clarification by the responsible expert is often necessary. This expert must then be notified by the operator in order to resolve the problem either by telephone or on site.

In this case, it is known to notify or contact the expert either by telephone or beeper. Given a telephone inquiry, the problem arises that the expert can usually not be directly reached since he or she is busy with other activities at different locations. A mere notification by beeper, in contrast, does not allow the expert to appreciate the urgency of the inquiry and act accordingly by reacting immediately, and recognizing the urgent necessity to go to the site, or whether to merely inquire by telephone. This considerably complicates the communication and causes unnecessary interruptions in the workflow.

### SUMMARY OF THE INVENTION

An object of the present invention is to provide a medical system architecture of the type initially described wherein a targeted notification of an expert is possible from the normal workflow without interruptions.

This object is inventively achieved in a medical system architecture of the type initially described wherein call system linked into the medical workflow for the transmission of messages, for example as datafiles, is allocated to at least one of the workstations. The user of a medical workstation, for example a modality, can send digital messages to an expert in an electronic manner proceeding from the console of the workstation. The medical modalities can be, for example, an MR, CT, ultrasound, X-ray or angiography device, a nuclear camera, supervision monitor, diagnostic workstation or irradiation apparatus. An automated expert call system to a mobile communication device proceeding from a workstation is thus obtained that is integrated into the work and data context of the medical workstation. Due to the combination of the workstation with a call system, a completely new application scenario arises wherein the radiologist—as an expert—is available by retrieval. This application scenario has not been realizable with the previous means (for example, image transfer to workstations).

It has proven advantageous for the call system to be designed such that manually modifiable entries of auxiliary information automatically ensue from object types stored in a data bank.

The call system has a user front end, a communication service and a mobile communication device. Advantageously, the user front end can be integrated in an application at the workstation.

The communication service can be a communication server and a communication system. The call system also can be realized with the assistance of an existing mobile radiotelephone network.

Operation is simplified when the call system is designed such that a manually modifiable entry of the addressee, of the current patient, of the current procedure and of auxiliary information from object types stored in a data bank automatically ensues.

The call system can be a mobile communication device with a display.

The scope of utilization can be expanded when the call system has a voice input that is transmitted to the communication device as an audio datafile and can be emitted at the communication device.

When the workstations have monitors, they can be fashioned such that a communication window can be mixed in on the respective monitors text to the examination images.

The questions can be answered or the recipient can react to the call when the call system has an information return channel from the communication device to the workstation.

The calling party can recognize that the call has been noted when the communication device is fashioned such that it sends a received confirmation to the workstation after the message has been read.

It has proven advantageous to employ Corba, Instant Messaging or Java Enterprise Beans as transmission technology between the workstations and communication service.

The user front end can be as a Java applet in a standard browser of, for example, Microsoft or Netscape.

Inventively, the mobile communication device can be a WAP cell phone, an SMS cell phone or a beeper with display.

### DESCRIPTION OF THE DRAWINGS

FIG. 1 schematically illustrates an example of a system architecture of a hospital network in which the invention can be employed.

FIG. 2 is a schematic illustration of the inventive call system.

FIG. 3 is a schematic illustration of a user interface of a monitor of the inventive system architecture.

### DESCRIPTION OF THE PREFERRED EMBODIMENTS

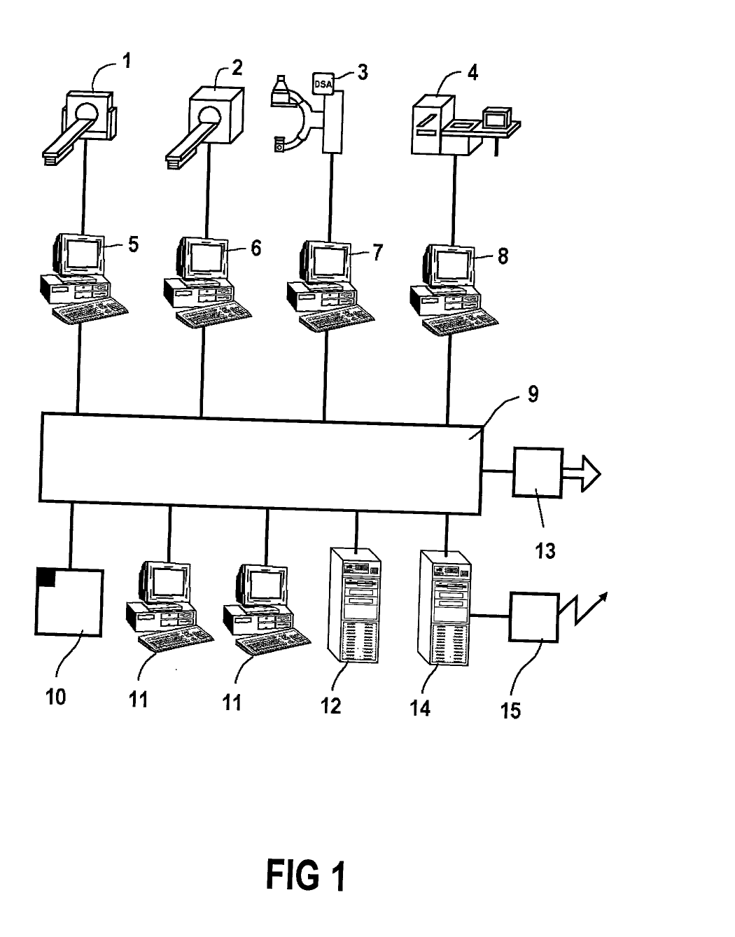

FIG. 1 shows the system architecture of a hospital network as an example. The modalities 1 through 4 serve for the acquisition of medical images; these can be, for example, a CT unit 1 for computed tomography, an MR unit 2 for magnetic resonance imaging, a DSA unit 3 for digital subtraction angiography and an X-ray unit 4 for digital radiography 4 as image-generating systems. Operator consoles (workstations) 5 through 8 of the modalities are connected to these modalities, the acquired medical images being processed and locally stored therewith. Patient data belonging to the images also can be entered.

For linking to a PACS, the operator consoles 5 through 8 are connected to a communication network 9, such a LAN/WAN backbone for distributing the generated images and for communication. Thus, for example, the images generated in the modalities 1 through 4 and the images that are further-processed in the operator consoles 5 through 8 can be stored in a central image storage and image archiving system 10 or can be forwarded to other workstations.

Further viewing workstation represented by a workstation 11 are connected to the communication network 9 as diagnostics consoles that have local image memories. For example, such a viewing workstation 11 is a very fast mini computer on the basis of one or more fast processors. The images that are acquired and deposited in the image archiving system can be subsequently called in the viewing workstation 11 for diagnosis and can be deposited in the local image memory, from which they can be immediately available to the diagnostician working at the viewing workstation 11.

Further, servers 12, for example patient data servers (PDS), file servers, program servers and/or EPR servers, are connected to the communication network 9.

The image and data exchange via the communication network 9 ensues according to the DICOM standard, an industry standard for the transmission of images and further medical information between computers, so that a digital communication between diagnosis and therapy devices of different manufacturers is possible. A network interface 13 via which the internal communication network 9 is connected to a global data network, for example the world wide web, can be connected to the communication network 9, so that the standardized data can be exchanged with different networks world-wide.

A communication server 14 that coordinates the sending and the reception of the messages is connected to the communication network 9. A communication system 15, for example a transmitter, that transmits the messages to a communication device (not shown in FIG. 1) is connected to the communication server 14. The communication system 15 can be a radio transmitter, a number of infrared transmitters or, for example, more complex components of a mobile radiotelephone network.

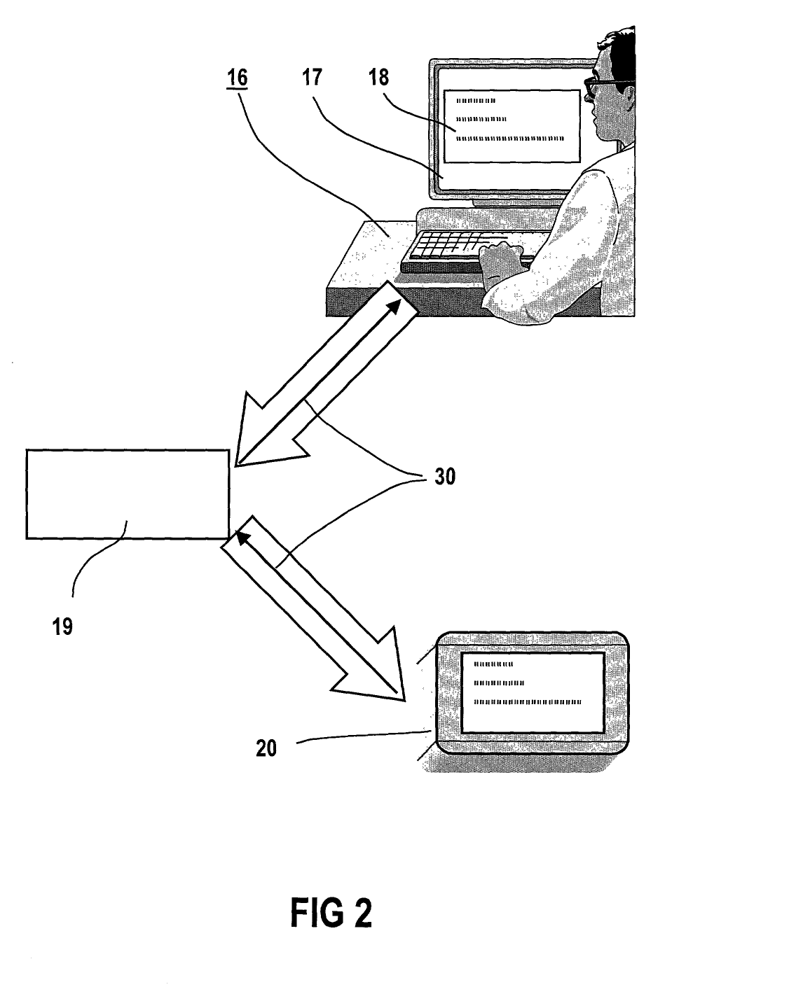

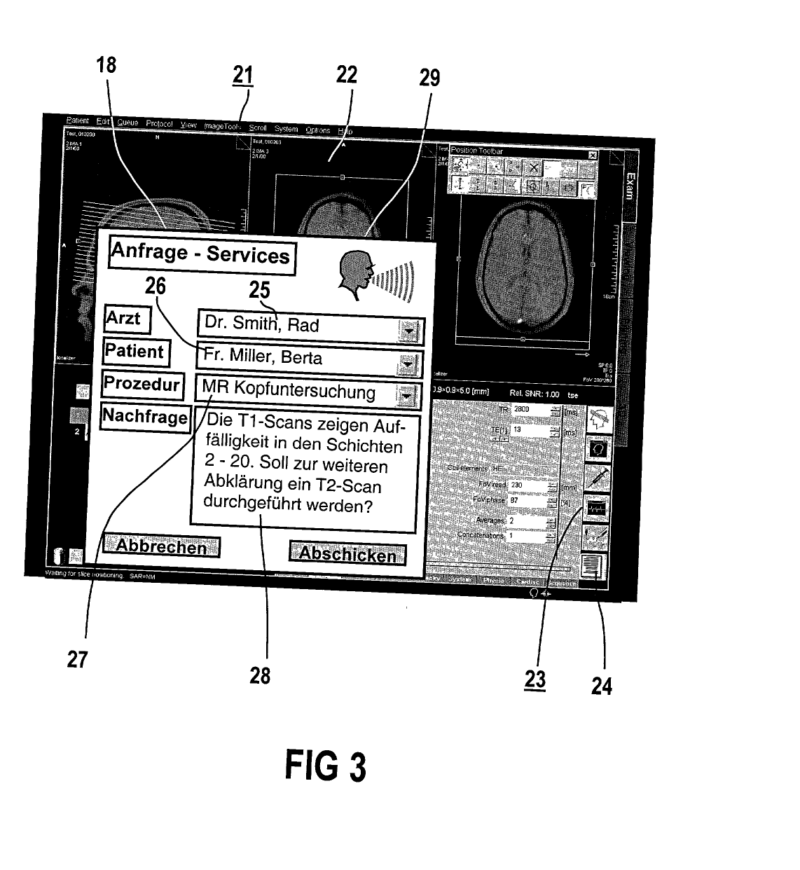

FIG. 2 shows a workstation 16 of an operator console 5 through 8 of one of the modalities 1 through 4 or of a viewing workstation 11, for example the operator console 6 of the MR unit 2. A communication window 18, which shall be described in greater detail with reference to FIG. 3, is mixed in on the monitor 17 of the workstation 16 as a user front end. The message that can be entered in this communication window 18 is transmitted, for example as a datafile, to a communication service 19 that can be composed of the communication server 14 and the communication system 15. This communication service routes the message to a mobile communication device 20 that, for example, can be a WAP cell phone, SMS cell phone or a beeper with display.

FIG. 3 shows the user interface 21 of the monitor 17 of the operator console 6 of the MR unit 2. An image processing window with a number of juxtaposed MR exposures is reproduced on the user interface 21, a control region 23 with icons for triggering commands being arranged next to this in a known way for operation.

When an expert is to be notified proceeding from the MR operator console 6 because a question or a problem arises during the examination or during the post-processing, then the communication window 18 can be opened on the user interface 21 of the operator console 6 of the MR unit 2 by clicking on the icon 24.

An input field 25 for the expert to be called is arranged in the communication window 18, this, for example, being pre-occupied by the name of the attending physician from the electronic patient record (EPR). The patient can be entered into a further name field 26, whereby the name of the patient is pre-occupied from the patient present at the operator console 6. An input field 27 for the procedure, pre-occupied from the current examination, can likewise be edited. The problem and the urgency can be briefly explained in a text field 28, so that the expert can react or reply immediately. By pressing the “send” button, the message is transmitted as datafile via the communication server 14 to the transmitter 15 and is then forwarded to the communication device 20 by radio or infrared light.

By clicking an audio icon 29, a voice input can ensue with a microphone (not shown), the voice input being communicated to the communication device 20 as audio datafile and being emitted thereat.

The call system also can have an information return channel 30 (shown in FIG. 2) from the communication device 20 to the workstation 16 via which the communication device 20 can send a received confirmation after reading the message.

However, an answer to the question asked of the expert also can be communicated either in text form—as a text datafile entered at the communication device 20 and sent to the workstation 16—or likewise by voice input with audio datafile.

As a result of the inventive fashioning of the medical system architecture, an automated expert call system is obtained that is composed of the following components:

user front end,

communication service 19, and

mobile communication device 20 of the expert.

The user front end, the communication window 18, can be integrated into one or more applications at the workstations 5 through 8 and 11 of the user. Such applications can be the patient browser, web browser and/or acquisition.

The user front end can, for example, contain the following functions:

Automatic entry of the addressee (expert), which can be manually modified.

Automatic acceptance of the current patient, which can be manually modified.

Automatic, manually modifiable entry of the current procedure (work step) that is being worked on at the moment.

Input possibility of auxiliary information such as, for example, the text field in which the user can enter his question.

By simple operating interaction, for example a button click, this user front end generates a message, for example as datafile, that contains at least the aforementioned information, i.e. context and text of the question. This message is forwarded by the communication service 19, for example an SW component of the workstation or a separate communication server 14, to the mobile communication device 20 of the expert, for example a WAP cell phone, SMS cell phone or a beeper with display.

An important advantage of the inventive embodiment of the medical system architecture, the integration of the relevant context (patient, procedure) in the workflow at the workstation into a call inquiry is automatic. In this way, the expert receives the information relevant for his or her reaction without redundant outlay on the part of the user.

In addition to the information, all object types present in the data bank can be configured as context information, for example from the fields of the DICOM study object.

In addition to the text field 28, a voice input can be provided that is transmitted to the communication device 20 as audio datafile and emitted thereat.

Corba, Instant Messaging or Java Enterprise Beans can be employed as the transmission technology between workstation and communication service.

The user front end can be a Java applet in a standard browser, for example Microsoft or Netscape.

Although modifications and changes may be suggested by those skilled in the art, it is the intention of the inventors to embody within the patent warranted hereon all changes and modifications as reasonably and properly come within the scope of their contribution to the art.

We claim as our invention:

1. A medical system architecture comprising:
a modality for acquiring examination images;
a workstation selected from the group of workstations consisting of workstations for acquiring said examination images, workstations for sending said examination image, and workstations for receiving said examination images;
a system connected to said workstation for transmitting said examination images to at least one location remote from said workstation; and
a call system allocated to said workstation for transmitting messages to a remote location.

2. A medical system architecture as claimed in claim 1 wherein said workstation also processes data associated with said examination images, and further comprising a memory connected to said system which stores said data and said examination images in allocated fashion.

3. A medical system architecture as claimed in claim 1 wherein said call system allows manually modifiable entries of auxiliary information to ensue automatically from object types stored in a data bank.

4. A medical system architecture as claimed in claim 1 wherein said call system comprises a user front end, a communication service and a mobile communication device.

5. A medical system architecture as claimed in claim 4 wherein said user front end is integrated in an application at said workstation.

6. A medical system architecture as claimed in claim 4 wherein said communication services comprises a communication server and a communication system.

7. A medical system architecture as claimed in claim 1 wherein said call system allows a manually modifiable entry of a message recipient to ensue automatically in said message.

8. A medical system architecture as claimed in claim 1 wherein said call system allows a manually modifiable entry of a current patient, being examined with said modality, to ensue automatically in said message.

9. A medical system architecture as claimed in claim 1 wherein said call system allows a manually modifiable entry of a current procedure being executed by said modality to ensue automatically in said message.

10. A medical system architecture as claimed in claim 1 wherein said call system allows entry of an arbitrary text as specific auxiliary information in said message.

11. A medical system architecture as claimed in claim 1 wherein said call system comprises a mobile communication device with a display.

12. A medical system architecture as claimed in claim 11 wherein said call system includes a voice input unit at said workstation allowing a voice input to be transmitted to said communication device as an audio data file, and wherein said communication device comprises an audio transducer allowing emission of said voice input at said communication device.

13. A medical system architecture as claimed in claim 1 wherein said workstation has a monitor on which said examination images are displayed, and wherein said call system is connected to said workstation to cause a communication window to be overlaid on said examination images at said monitor.

14. A medical system architecture as claimed in claim 1 wherein said call system comprises a mobile communication device with a display and an information return channel from said communication device to said workstation allowing information to be transmitted from said communication device to said workstation.

15. A medical system architecture as claimed in claim 14 wherein said communication device transmits a confirmation of receipt of said message to said workstation after said message has been read at said communication device.

16. A medical system architecture as claimed in claim 1 wherein said call system comprises a user front end, a communication service and a mobile communication device, and wherein said workstation communicates with said communication service via Corba technology.

17. A medical system architecture as claimed in claim 1 wherein said call system comprises a user front end, a communication service and a mobile communication device, and wherein said workstation communicates with said communication service via Instant Messaging technology.

18. A medical system architecture as claimed in claim 1 wherein said call system comprises a user front end, a communication service and a mobile communication device, and wherein said workstation communicates with said communication service via Java Enterprise Beans technology.

19. A medical system architecture as claimed in claim 1 wherein said call system comprises a user front end, a communication service and a mobile communication device, and wherein said user front end comprises a Java applet in a browser.

20. A medical system architecture as claimed in claim 1 wherein said call system comprises a user front end, a communication service and a WAP cell phone.

21. A medical system architecture as claimed in claim 1 wherein said call system comprises a user front end, a communication service and a SAS cell phone.

22. A medical system architecture as claimed in claim 1 wherein said call system comprises a user front end, a communication service and a beeper with a display.
